(19) United States
(12) Patent Application Publication
(10) Pub. No.: US 2026/0310143 A1
(43) Pub. Date: Oct. 8, 2026

(54) PARAMETER ADJUSTMENT DEVICE AND COMPUTER-READABLE RECORDING MEDIUM

(71) Applicant: FANUC CORPORATION, Yamanashi (JP)

(72) Inventors: Aoki Shunsuke, Minamitsuru-gun, Yamanashi (JP); Nobuaki AIZAWA, Minamitsuru-gun, Yamanashi (JP); Tomokazu Kayanuma, Minamitsuru-gun, Yamanashi (JP); Daijirou Koga, Minamitsuru-gun, Yamanashi (JP)

(73) Assignee: FANUC CORPORATION, Yamanashi (JP)

(21) Appl. No.: 19/480,133

(22) PCT Filed: May 11, 2023
(86) PCT No.: PCT/JP2023/017774

§ 371 Date: Oct. 30, 2025

(51) Int. Cl. G05B 13/02

(52) U.S. Cl. CPC G05B 13/024

(57) ABSTRACT

A parameter adjustment device according to the present disclosure is provided with: a state acquisition unit that acquires, as state data, a control amount relating to a drive shaft when an evaluation program is run on an industrial machine; a tool tip error calculation unit that kinematically transforms the state data and calculates the error in at least one of machining accuracy and machined surface quality; a target acquisition unit that acquires a target value of the error in at least one of machining accuracy and machined surface quality; a parameter calculation unit that compares the error calculated by the tool tip error calculation unit with the target value of the error as acquired by the target acquisition unit, and calculates a parameter value on the basis of the comparison result; and a parameter adjustment unit that adjusts the parameter value calculated by the parameter calculation unit to the industrial machine.

### CROSS-REFERENCE TO RELATED APPLICATIONS

This is the U.S. National Phase application of PCT/JP2023/017774, filed May 11, 2023, the disclosure of this application being incorporated herein by reference in its entirety for all purposes.

### FIELD OF THE INVENTION

The present disclosure generally relates to a parameter adjustment device and a computer-readable recording medium.

### BACKGROUND OF THE INVENTION

A workpiece is machined by controlling a machine tool based on a machining program, and a product such as a part or a die is manufactured. In manufacturing the product, target machining accuracy and machined surface quality are set in advance. In addition, a target machining time is determined in advance. An operator of the machine tool adjusts a parameter such as an acceleration/deceleration time constant and a moving speed commanded in the machining program while checking machining accuracy of the product after machining, machined surface quality, etc. There is technology for setting target values for machining accuracy and machined surface quality, and adjusting acceleration/deceleration parameters using machine learning so that the machining accuracy and the machined surface quality fall within the target values (for example, Patent Document 1, etc.).

### PATENT LITERATURE

Patent Document 1: International Publication No. 2022/224450

### BRIEF DESCRIPTION OF DRAWINGS

FIG. 1 is a schematic hardware configuration diagram of a parameter adjustment device according to a first embodiment;

FIG. 2 is a block diagram illustrating schematic functions of the parameter adjustment device according to the first embodiment;

FIG. 3 is a schematic configuration diagram of a 5-axis machining device including three linear axes and two rotating axes;

FIG. 4 is a table illustrating state data of the 5-axis machining device acquired by a state acquisition unit;

FIG. 5 is a schematic diagram illustrating an example in which a commanded position of a tool tip and an actual position of the tool tip are plotted in space;

FIG. 6 is a table illustrating an example of a parameter calculation rule by a parameter calculation unit;

FIG. 7 illustrates an example of a guideline for parameter adjustment; and

FIG. 8 is a block diagram illustrating schematic functions of a parameter adjustment device according to a modified example.

### DETAILED DESCRIPTION OF EMBODIMENTS OF THE INVENTION

A machine having a plurality of intricately interrelated axes needs to evaluate and adjust movement of a tip of a tool that machines a workpiece rather than movement of an individual axis. Examples thereof include a machining device using a parent-child turtle system in which a certain axis and another axis are moved in the same direction, a machining device having an axis obliquely inclined at a certain angle with respect to another axis, a machining device including a linear axis and a rotating axis, etc. Such a machining device has a problem in that it is difficult to detect an influence of movement of an axis at a certain time on a tip of a tool. For example, even when a axis is moved at a specified speed considering a command speed, a tool tip speed may not be sufficient due to an influence of another axis. In addition, since the linear axis and the rotating axis are evaluated by different indices, that is, the linear axis is evaluated by a length index (e.g., mm) and the rotating axis is evaluated by an angle index (e.g., deg), it is difficult to perform adjustment by evaluating movement of the tool tip.

In production sites, there is demand for an adjustment method that makes it easy to evaluate movement at the tool tip.

According to the disclosure, a parameter adjustment device of an industrial machine according to the disclosure solves the above-mentioned problem by performing kinematic transformation and allowing a parameter to be adjusted using an error at a tool tip.

Further an aspect of the disclosure is a parameter adjustment device including a state acquisition unit configured to acquire, as state data, a control amount related to a drive axis when an evaluation program is operated in an industrial machine, a tool tip error calculation unit configured to perform kinematic transformation on the state data and calculate an error of at least one of machining accuracy and machined surface quality, a target acquisition unit configured to acquire a target value of the error of at least one of the machining accuracy and the machined surface quality, a parameter calculation unit configured to compare the error calculated by the tool tip error calculation unit with the target value of the error acquired by the target acquisition unit, and calculate a value of the parameter based on a result of the comparison, and a parameter adjustment unit configured to adjust the value of the parameter calculated by the parameter calculation unit to the industrial machine.

Hereinafter, embodiments of the disclosure will be described with reference to the drawings.

### First Embodiment

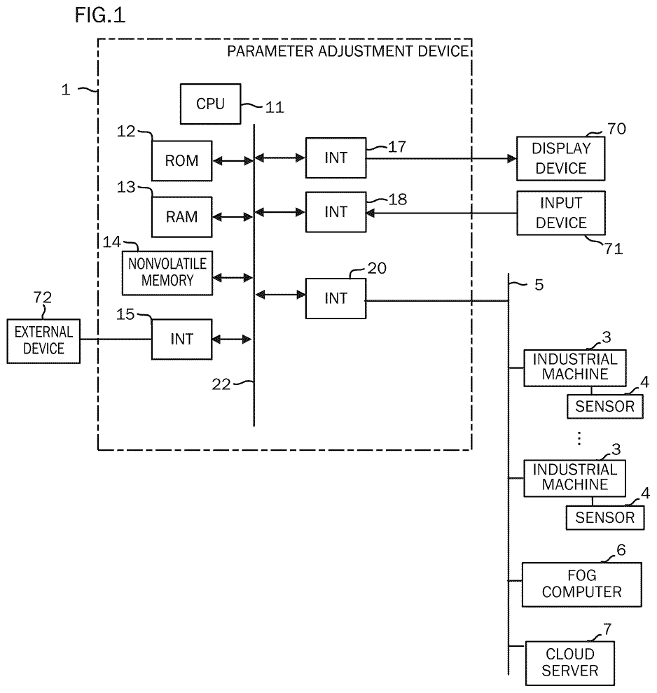

FIG. 1 is a schematic hardware configuration diagram illustrating main parts of a parameter adjustment device according to an embodiment of the disclosure. The parameter adjustment device 1 according to this embodiment can be installed as a controller that controls an industrial machine such as a machine tool configured to move a drive unit along a linear axis and a rotating axis by driving a motor. In addition, the parameter adjustment device 1 according to this embodiment can be installed on a computer such as a personal computer attached to the controller that controls the industrial machine, a personal computer connected to the controller via a wired/wireless network, a cell computer, a fog computer 6, or a cloud server 7. The following illustrates an example in which the parameter adjustment device 1 is installed on the personal computer connected to the controller that controls the industrial machine 3 via a network 5.

A CPU 11 included in the parameter adjustment device 1 according to this embodiment is a processor that controls the parameter adjustment device 1 as a whole. The CPU 11 reads a system program stored in a ROM 12 via a bus 22, and controls the entire parameter adjustment device 1 in accordance with the system program. A RAM 13 temporarily stores temporary calculation data, display data, various data input from the outside, etc.

For example, a nonvolatile memory 14 includes a memory backed up by a battery (not illustrated), an SSD (Solid State Drive), etc., and a storage state is maintained even when the power supply of the parameter adjustment device 1 is turned off. The nonvolatile memory 14 stores control programs and data read from an external device 72 via an interface 15, data and control programs input via an input device 71, each piece of data acquired from the industrial machine 3, etc. The control programs and data stored in the nonvolatile memory 14 may be loaded in the RAM 13 during execution/use. In addition, various system programs such as known analysis programs are written in advance in the ROM 12.

For example, the industrial machine 3 is a machine tool such as a machining center or a lathe including at least one linear axis and at least one rotating axis. A sensor 4, which detects physical quantities such as current, voltage, and vibration of each unit during operation of the industrial machine 3, is attached to the industrial machine 3. In response to a request from the parameter adjustment device 1, the industrial machine 3 transmits data such as a command position according to a control program during machining, and a position, a speed, acceleration, jerk, vibration, and a machining time of each axis via the network 5.

The interface 15 is an interface for connecting the CPU 11 of the parameter adjustment device 1 to the external device 72 such as a USB memory, a Compact Flash (registered trademark), or an SD card. For example, pre-stored control programs, various data, etc. can be read from the external device 72. In addition, it is possible to cause the external device 72 to store control programs, various data, etc. edited in the parameter adjustment device 1.

Each piece of data read into the memory, data obtained as a result of executing a program, etc., are output via the interface 17 and displayed on a display device 70. In addition, the input device 71 including a keyboard, a pointing device, etc., transfers a command, data, etc. based on an operation by an operator to the CPU 11 via an interface 18.

The interface 20 is an interface for connecting the CPU 11 of the parameter adjustment device 1 to the wired or wireless network 5. For example, the network 5 may perform communication using technologies such as serial communication such as RS-485, Ethernet (registered trademark) communication, optical communication, wireless LAN, Wi-Fi (registered trademark), and Bluetooth (registered trademark). The industrial machine 3, the fog computer 6, the cloud server 7, etc. are connected to the network 5 to mutually exchange data with the parameter adjustment device 1.

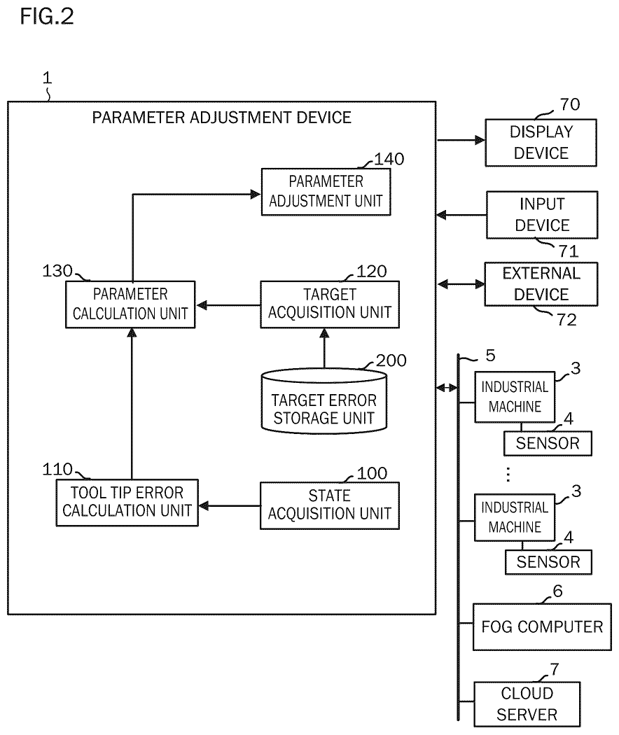

FIG. 2 illustrates functions of the parameter adjustment device 1 according to the first embodiment of the disclosure as a schematic block diagram. Each function of the parameter adjustment device 1 according to this embodiment is realized by the CPU 11 included in the parameter adjustment device 1 illustrated in FIG. 1 executing a system program and controlling an operation of each unit of the parameter adjustment device 1.

The parameter adjustment device 1 of this embodiment includes a state acquisition unit 100, a tool tip error calculation unit 110, a target acquisition unit 120, a parameter calculation unit 130, and a parameter adjustment unit 140. In addition, a target error storage unit 200, which is a region storing an error related to a target position and an error related to a speed, is prepared in advance on the RAM 13 or the nonvolatile memory 14 of the parameter adjustment device 1.

The state acquisition unit 100 acquires a control amount related to a drive axis of the industrial machine 3 as state data. For example, the control amount related to the drive axis of the industrial machine 3 may include data indicating a command position of each drive axis commanded by a control program. In addition, data indicating an actual position of each drive axis included in the industrial machine 3 may be included. Furthermore, the state acquisition unit 100 preferably acquires a parameter related to control of a movement amount including an Nth order time differential element (N being a natural number) during control of the industrial machine 3. Examples of this parameter include linear acceleration [mm/sec²], linear jerk [mm/sec³], a corner speed difference [mm/min], a post-interpolation acceleration/deceleration time constant [msec], position loop gain, and a feedforward coefficient. When the state acquisition unit 100 acquires the control amount related to the drive axis as state data, a predetermined control program for evaluation (hereinafter referred to as an evaluation program) created in advance in the industrial machine 3 may be operated to acquire a command position of each drive axis according to each command commanded by the evaluation program and a shift of the actual position of each drive axis during operation according to each command. With regard to the shift of the actual position of each drive axis, for example, the actual position of each drive axis may be acquired for each predetermined sampling period. The state acquisition unit 100 may acquire a time taken from the start to the end of control based on the evaluation program. The state acquisition unit 100 outputs the acquired state data to the tool tip error calculation unit 110.

The tool tip error calculation unit 110 kinematically transforms input state data and calculates a maximum value of an error of an actual position with respect to a position of the tool tip according to a command. In this embodiment, kinematic transformation is transformation from a position of each drive axis to the position of the tool tip using a mathematical expression that indicates a relationship between the position of each drive axis and the tool tip position derived based on a configuration of the industrial machine 3. The tool tip error calculation unit 110 performs kinematics transformation based on the command position of each drive axis to calculate the position of the tool tip according to the command. In addition, the tool tip error calculation unit 110 performs kinematics transformation based on the actual position of each drive axis to calculate an actual position of the tool tip. Then, a difference between the position of the tool tip according to the command and the actual position of the tool tip obtained by kinematics transformation is calculated as an error related to the position of the tool tip.

The tool tip error calculation unit 110 may calculate a difference between a command speed according to each command and an actual speed calculated based on a shift of the actual position of the tool tip obtained by kinematic conversion as an error related to the speed of the tool tip. In addition, similarly, an error related to acceleration and an error related to jerk of the tool tip may be calculated. The tool tip error calculation unit 110 outputs a maximum value of each calculated error to the parameter calculation unit 130.

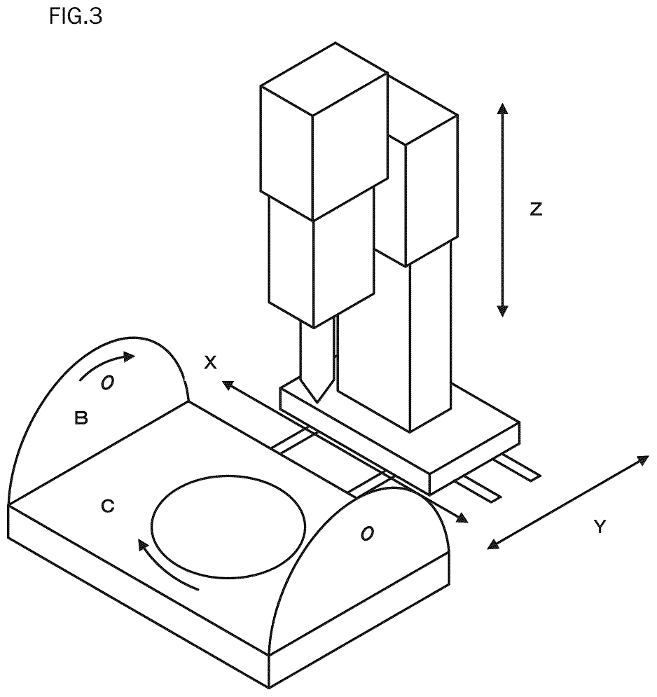

Hereinafter, a description will be given of calculation of an error by the tool tip error calculation unit 110 with reference to FIGS. 3 to 5.

FIG. 3 is a schematic configuration diagram of a 5-axis machining device including three linear axes (an X-axis, a Y-axis, and a Z-axis) and two rotating axes (a B-axis and a C-axis). In the 5-axis machining device illustrated in FIG. 3, the tool is moved by driving the three linear axes, namely, the X-axis, the Y-axis, and the Z-axis. Meanwhile, the two rotating axes, namely, the B-axis and the C-axis rotates a table. In the evaluation program, for example, the position of each drive axis is commanded.

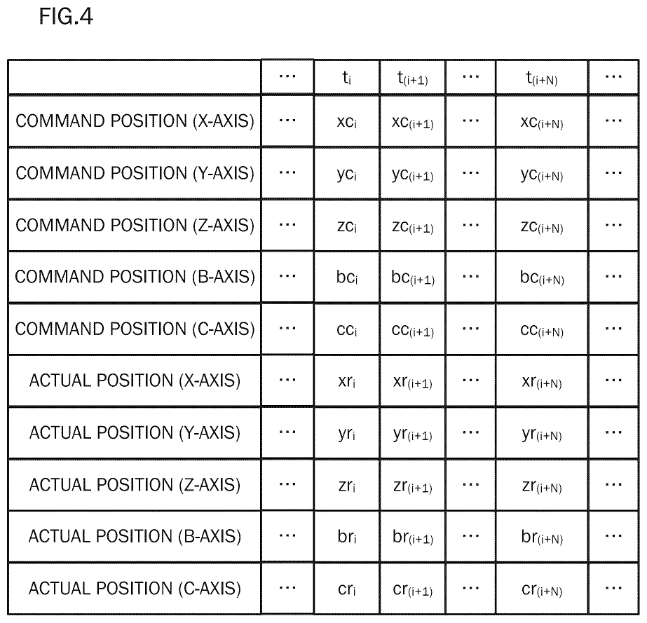

FIG. 4 is a table diagram illustrating state data of the 5-axis machining device acquired by a state acquisition unit 100. As illustrated in FIG. 4, state data includes a command position commanded for each drive axis and an actual position of each drive axis. Time tᵢ, t₍ᵢ₊₁₎, t₍ᵢ₊₂₎, . . . are times for each predetermined sampling period. In an example of FIG. 4, positions of XCᵢ, yCᵢ, ZCᵢ, bCᵢ, and CCᵢ are commanded for the respective axes at timing of time tᵢ, positions of XCᵢ₊₁₎, yCᵢ₊₁₎, ZC₍ᵢ₊₁₎, bc₍ᵢ₊₁₎, and CC₍ᵢ₊₁₎ are commanded for the respective axes at timing of time t₍ᵢ₊₁₎, and a position of each drive axis is commanded by the evaluation program. In addition, the actual position of each drive axis is acquired as feedback data of the motor that drives each drive axis for each predetermined sampling period.

The tool tip error calculation unit 110 calculates a commanded position of the tool tip and the actual position of the tool tip by performing kinematic transformation on the command position of each drive axis and the actual position of each drive axis included in the state data acquired in this manner. Specific calculation of kinematic transformation is previously publicly known, for example, in JP 2019-057262 A, and therefore a detailed description thereof is omitted in this specification.

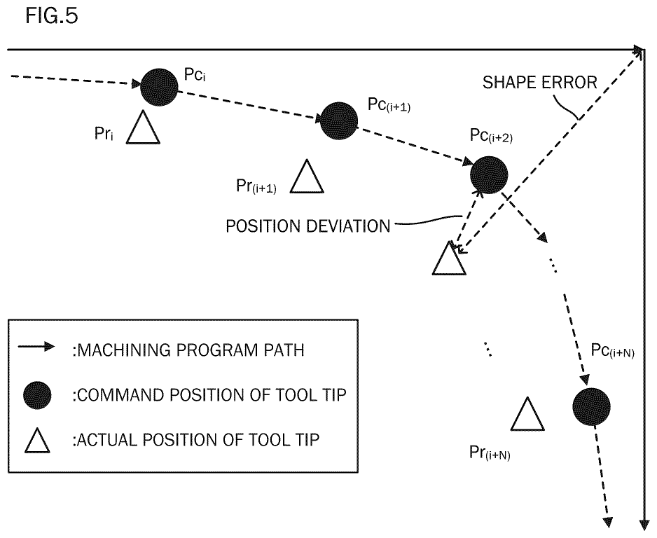

FIG. 5 is a schematic diagram illustrating an example in which a machining program path, a command position of the tool tip, and an actual position of the tool tip are plotted in space. In FIG. 5, a solid arrow indicates the machining program path. In addition, a black circle indicates the commanded position of the tool tip.

Furthermore, a white triangle indicates the actual position of the tool tip. Pcᵢ=(xkcᵢ, ykcᵢ, zkcᵢ) denotes a commanded position of the tool tip obtained by performing kinematic transformation based on positions XCᵢ, yCᵢ, ZCᵢ, bcᵢ, and ccᵢ commanded for the respective drive axes at time tᵢ. In addition, Pc₍ᵢ₊₁₎=(xkc₍ᵢ₊₁₎, ykc₍ᵢ₊₁₎, zkc₍ᵢ₊₁₎ denotes a commanded position of the tool tip obtained by performing kinematic transformation based on positions xC₍ᵢ₊₁₎, yC₍ᵢ₊₁₎, ZC₍ᵢ₊₁₎, bc₍ᵢ₊₁₎, and cc₍ᵢ₊₁₎ commanded for the respective drive axes at time t₍ᵢ₊₁₎. Meanwhile, Prᵢ=(xkrᵢ, ykrᵢ, zkrᵢ) denotes a commanded actual position of the tool tip obtained by performing kinematic transformation based on actual positions xrᵢ, yrᵢ, zrᵢ, brᵢ, and crᵢ of the respective drive axes at time tᵢ. In an example of FIG. 5, it is assumed that linear interpolation is performed between respective command positions. In such a case, for example, a position deviation can be calculated as a distance from an actual position Pr₍ᵢ₊₁₎ of the tool tip to a command position Pc₍ᵢ₊₁₎. In addition, for example, a shape error can be calculated as a distance from the actual position Pr₍ᵢ₊₁₎ of the tool tip to the machining program path. Furthermore, for example, a vibration error can be calculated based on an amplitude value of a frequency component included in a difference between a path of the actual position and a command path. The tool tip error calculation unit 110 calculates an error related to each actual position and outputs a maximum value thereof to the parameter calculation unit 130 as a maximum actual position error.

In addition, a value obtained by dividing a distance between respective actual positions by a time difference may be calculated as an actual speed, and a difference between the calculated actual speed and a command speed may be calculated as a speed error at each actual position. Furthermore, a difference in actual speed may be calculated as actual acceleration at each actual position, and a difference between the calculated actual acceleration and maximum acceleration may be calculated as an acceleration error at each actual position. This is similarly applied to a jerk error. Then, the calculated value is output to the parameter calculation unit 130.

The target acquisition unit 120 acquires a target value of an error of at least one of machining accuracy and machined surface quality. Examples of a target error include a target shape error as a target error of the machining accuracy, a target position deviation as a target error of the machined surface quality, a target vibration error, etc. For example, the target acquisition unit 120 may read and acquire a target error related to a position or a target error related to a speed stored in advance in the target error storage unit 200. In addition, the target acquisition unit 120 may display a screen (not illustrated) for setting a target error on the display device 70, and acquire a target error related to a position, a target error related to a speed, etc. based on input from the operator.

Furthermore, the target error related to the position, the target error related to the speed, etc. may be acquired from another computer such as the fog computer 6 or the cloud server 7.

The parameter calculation unit 130 compares an error calculated by the tool tip error calculation unit 110 with a target error acquired by the target acquisition unit 120. Then, a value of a parameter related to control of the industrial machine 3 is calculated based on a result of the comparison. An object of calculating the value of the parameter is to adjust the value of the parameter so that a time required for an operation of the industrial machine 3 based on the evaluation program is minimized within a range in which the error calculated by the tool tip error calculation unit 110 falls within the target error value acquired by the target acquisition unit 120. Parameters calculated by the parameter calculation unit 130 are parameters related to control of a movement amount per control cycle including Nth order time differential elements (N being a natural number) such as linear acceleration [mm/sec²], linear jerk [mm/sec³], a corner speed difference [mm/min], a post-interpolation acceleration/deceleration time constant [msec], position loop gain, and a feedforward coefficient.

The parameter calculation unit 130 may calculate parameters by adjusting respective values of respective parameters acquired by the state acquisition unit 100 from the industrial machine 3 according to a predetermined calculation rule. For example, the calculation rule is a rule that sets how to change each parameter when a result of the comparison between the error calculated by the tool tip error calculation unit 110 and the target error acquired by the target acquisition unit 120 meets a predetermined condition.

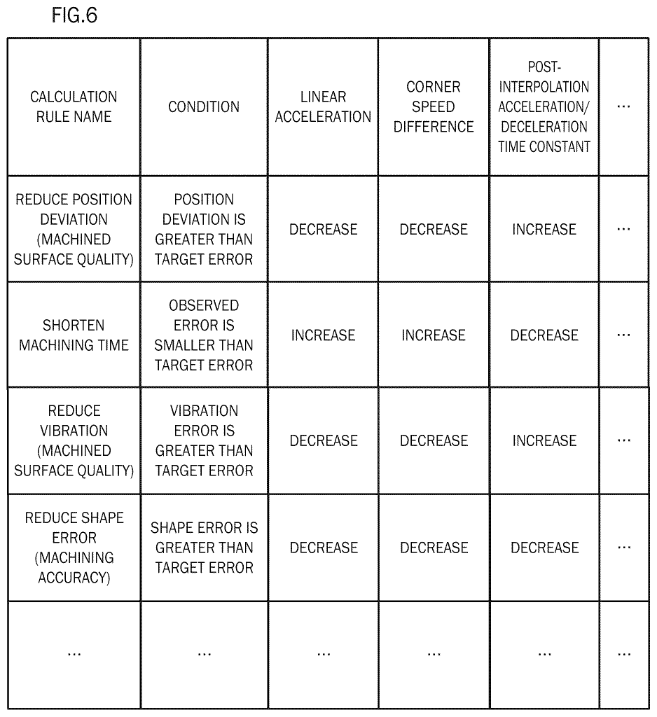

FIG. 6 is a table illustrating an example of a parameter calculation rule by the parameter calculation unit 130. In the example of FIG. 6, a rule for reducing a position deviation, a rule for shortening a machining time, a rule for reducing vibration, a rule for reducing a shape error, etc. are defined. For each calculation rule, a condition for applying the calculation rule is set. For example, as a result of comparing an error calculated by the tool tip error calculation unit 110 with a target error acquired by the target acquisition unit 120, when the error related to the position is greater than the target error, the rule for reducing the position deviation is adopted. When this rule is adopted, the parameter calculation unit 130 sets a parameter value of linear acceleration to be smaller than a current value. In addition, a parameter value of a corner speed difference is set to be smaller than the current value. Furthermore, a parameter value of post-interpolation acceleration/deceleration is set to be greater than the current value. With regard to the extent to which each parameter value is increased/decreased, a predetermined value may be determined in advance, or the extent may be changed according to the comparison result between the error calculated by the tool tip error calculation unit 110 and the target error acquired by the target acquisition unit 120. For example, a change amount of the parameter value may be increased according to the amount by which the calculated error exceeds the target error. In addition, when the calculated error exceeds the target error, the change amount of the parameter value may be weighted and changed for each axis according to the movement amount of each axis.

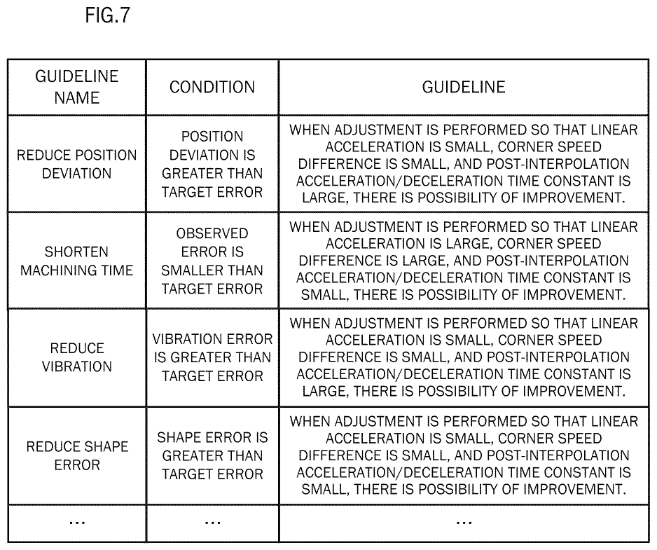

The parameter calculation unit 130 may calculate parameters manually by an operation of the operator. In such a configuration, the parameter calculation unit 130 displays and shows the comparison result between the error calculated by the tool tip error calculation unit 110 and the target error acquired by the target acquisition unit 120 to the operator, and presents a current value of each parameter and an interface for changing the value. In this instance, the parameter calculation unit 130 may display a guideline for parameter adjustment based on a comparison result between the current error and the target error. FIG. 7 illustrates an example of the guideline for parameter adjustment.

When a predetermined condition is satisfied, the parameter calculation unit 130 ends calculation of a parameter value related to control of the industrial machine 3. The predetermined condition may be set for each type of error. For example, the predetermined condition may be a condition in which, when a predetermined threshold value is set in advance for each type of error, and all differences between calculated errors and the target error are less than or equal to the predetermined threshold value, calculation of the parameter value related to control of the industrial machine 3 is ended. In addition, an upper limit may be set on the number of times that the parameter calculation unit 130 calculates a parameter and the parameter adjustment unit 140 adjusts the parameter. The parameter calculation unit 130 may count the number of times that the parameter is calculated and adjusted, and end calculation of the parameter value related to control of the industrial machine 3 when the number of times reaches the upper limit. For example, the upper limit on the number of times of adjustment may be acquired by the target acquisition unit 120.

When the parameter calculation unit 130 calculates a parameter value, the parameter adjustment unit 140 sets the calculated parameter value to the industrial machine 3. Then, the industrial machine 3 is commanded to perform control based on the evaluation program. Then, the state acquisition unit 100 is commanded to acquire the control amount related to the drive axis of the industrial machine 3 as state data.

The parameter adjustment device 1 having the above configuration can evaluate an operation of the tool tip and adjust parameters for the industrial machine 3 having a plurality of intricately interrelated axes. Since movement of a tool tip point other than each drive axis is evaluated, it is possible to intuitively and easily adjust parameter values even for the industrial machines 3 including an inclined axes or a rotating axis.

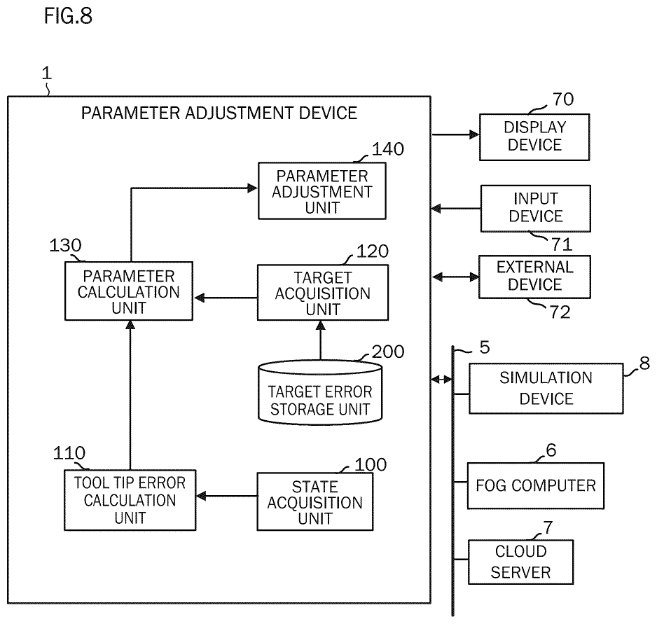

As a modified example of the parameter adjustment device 1 according to this embodiment, the parameter adjustment device 1 may be used to adjust operation parameters in a simulation device that imitates an operation of the industrial machine 3. In the case of such a configuration, as illustrated in FIG. 8, the parameter adjustment device 1 and the simulation device 8 are connected via the network 5. Then, the state acquisition unit 100 acquires, as state data, a control amount related to the drive axis of the virtual industrial machine 3 from the simulation device 8 that executes a simulation process based on the evaluation program. Furthermore, when the parameter calculation unit 130 calculates a parameter value, the parameter adjustment unit 140 sets the calculated parameter value to the simulation device 8. By adopting such a configuration, the operation of the tool tip can be evaluated and the parameters can be adjusted at high speed for the industrial machine 3 having the plurality of intricately interrelated axes without using the actual industrial machine 3. Since the actual industrial machine 3 is not used, it is possible to repeatedly adjust parameters without worrying about wear and tear on parts of the industrial machine 3.

As another modified example of the parameter adjustment device 1 according to this embodiment, in addition to the above-described method using the calculation rule, for example, the parameter calculation unit 130 may perform full search of values for each parameter, or may utilize reinforcement learning, an optimization method, etc. of publicly known technology. These parameter calculation methods are particularly useful when adjusting parameters for the simulation device. When performing full search for parameter values or using an optimization method such as reinforcement learning, it is necessary to repeatedly execute the evaluation program to adjust the parameters. When using the simulation device, a physical mechanical configuration does not fail even when the device is repeatedly operated, and thus it is possible to efficiently adjust the parameters to appropriate values.

As another modified example of the parameter adjustment device 1 according to this embodiment, the target acquisition unit 120 may further acquire an adjustment range of each parameter value. Then, the parameter calculation unit 130 calculates each parameter value within the adjustment range of each parameter value acquired by the target acquisition unit 120. In this way, it is possible to prevent the parameter calculation unit 130 from calculating a parameter value that cannot be set.

As another modified example of the parameter adjustment device 1 according to this embodiment, the state acquisition unit 100 may acquire at least one of a mechanical configuration of the industrial machine 3, a predetermined offset amount of a tool, a workpiece, etc., and information related to coordinate transformation between predetermined coordinate systems. The information acquired in this manner is used for the tool tip error calculation unit 110 to perform kinematic transformation. The mechanical configuration includes a relationship between the respective axes, etc. In addition, the offset amount of the tool or the offset amount of the workpiece can be used to correct a position of the tool tip. Furthermore, when control using different coordinate systems is performed in the evaluation program, kinematic transformation is performed after transforming coordinates of each drive axis using information related to coordinate transformation between the coordinate systems. In this way, it becomes possible to handle various configurations of the industrial machine 3.

Even though the embodiments of the disclosure have been described in detail above, the disclosure is not limited to the above-described individual embodiments. Various additions, substitutions, modifications, partial deletions, etc. are possible in these embodiments without departing from the gist of the invention or without departing from the idea and intent of the disclosure derived from content described in the claims and equivalents thereto. For example, in the above-described embodiments, an order of respective operations and an order of respective processes are illustrated as examples and the disclosure is not limited thereto. In addition, this is similarly applied when numerical values or mathematical expressions are used in the description of the above-described embodiments.

The following are notes for embodiments of the present disclosure.

### (Note 1)

A parameter adjustment device (1) according to an aspect of the disclosure comprises:
a state acquisition unit (100) configured to acquire, as state data, a control amount related to a drive axis when an evaluation program is operated in an industrial machine (3);
a tool tip error calculation unit (110) configured to perform kinematic transformation on the state data and calculate an error of at least one of machining accuracy and machined surface quality;
a target acquisition unit (120) configured to acquire a target value of the error of at least one of the machining accuracy and the machined surface quality;
a parameter calculation unit (130) configured to compare the error calculated by the tool tip error calculation unit (110) with the target value of the error acquired by the target acquisition unit (120), and calculate a value of a parameter related to an operation of the industrial machine (3) based on a result of the comparison; and
a parameter adjustment unit (140) configured to adjust the value of the parameter calculated by the parameter calculation unit (130) to the industrial machine (3).

### (Note 2)

The parameter adjustment device (1) according to another aspect of the disclosure, wherein:
the state acquisition unit (100) acquires at least one of a mechanical configuration of the industrial machine (3), a predetermined offset amount, and information related to coordinate transformation, and
the tool tip error calculation unit (110) calculates an error by performing kinematic transformation on the state data based on at least one of the mechanical configuration of the industrial machine (3), the predetermined offset amount, and the information related to coordinate transformation.

### (Note 3)

The parameter adjustment device (1) according to another aspect of the disclosure, wherein:
the target acquisition unit (120) acquires an adjustment range for the value of the parameter, and
the parameter calculation unit (130) calculates the parameter within the adjustment range.

### (Note 4)

The parameter adjustment device (1) according to another aspect of the disclosure, wherein:
the target acquisition unit (120) acquires an upper limit of a number of times of adjustment of the value of the parameter, and
when calculation of the value of the parameter reaches the upper limit of the number of times, the parameter calculation unit (130) ends calculation of the parameter by the parameter calculation unit (130) and adjustment of the parameter by the parameter adjustment unit (140).

### (Note 5)

The parameter adjustment device (1) according to another aspect of the disclosure, wherein:
the state acquisition unit (100) acquires a time taken to operate the evaluation program, and
the parameter calculation unit (130) calculates the value of the parameter so that a time taken to operate the industrial machine (3) based on the evaluation program is shortest in a range in which the error calculated by the tool tip error calculation unit (110) falls within the target value of the error acquired by the target acquisition unit.

### (Note 6)

A computer-readable recording medium, according to an aspect of the disclosure, recording a program for causing a computer to operate as:
a state acquisition unit (100) configured to acquire, as state data, a control amount related to a drive axis when an evaluation program is operated in an industrial machine (3),
a tool tip error calculation unit (110) configured to perform kinematic transformation on the state data and calculate an error of at least one of machining accuracy and machined surface quality,
a target acquisition unit (120) configured to acquire a target value of the error of at least one of the machining accuracy and the machined surface quality,
a parameter calculation unit (130) configured to compare the error calculated by the tool tip error calculation unit (110) with the target value of the error acquired by the target acquisition unit (120), and calculate a value of a parameter related to an operation of the industrial machine (3) based on a result of the comparison, and
a parameter adjustment unit (140) configured to adjust the value of the parameter calculated by the parameter calculation unit (130) to the industrial machine (3).

1. A parameter adjustment device comprising:
a state acquisition unit configured to acquire, as state data, a control amount related to a drive axis when an evaluation program is operated in an industrial machine;
a tool tip error calculation unit configured to perform kinematic transformation on the state data and calculate an error of at least one of machining accuracy and machined surface quality;
a target acquisition unit configured to acquire a target value of the error of at least one of the machining accuracy and the machined surface quality;
a parameter calculation unit configured to compare the error calculated by the tool tip error calculation unit with the target value of the error acquired by the target acquisition unit, and calculate a value of a parameter related to an operation of the industrial machine based on a result of the comparison; and
a parameter adjustment unit configured to adjust the value of the parameter calculated by the parameter calculation unit to the industrial machine.

2. The parameter adjustment device according to claim 1, wherein:
the state acquisition unit acquires at least one of a mechanical configuration of the industrial machine, a predetermined offset amount, and information related to coordinate transformation, and
the tool tip error calculation unit calculates an error by performing kinematic transformation on the state data based on at least one of the mechanical configuration of the industrial machine, the predetermined offset amount, and the information related to coordinate transformation.

3. The parameter adjustment device according to claim 1, wherein:
the target acquisition unit acquires an adjustment range for the value of the parameter, and
the parameter calculation unit calculates the parameter within the adjustment range.

4. The parameter adjustment device according to claim 1, wherein:
the target acquisition unit acquires an upper limit of a number of times of adjustment of the value of the parameter, and
when calculation of the value of the parameter reaches the upper limit of the number of times, the parameter calculation unit ends calculation of the parameter by the parameter calculation unit and adjustment of the parameter by the parameter adjustment unit.

5. The parameter adjustment device according to claim wherein:
the state acquisition unit acquires a time taken to operate the evaluation program, and
the parameter calculation unit calculates the value of the parameter so that a time taken to operate the industrial machine based on the evaluation program is shortest in a range in which the error calculated by the tool tip error calculation unit falls within the target value of the error acquired by the target acquisition unit.

6. A computer-readable recording medium recording a program for causing a computer to operate as:
a state acquisition unit configured to acquire, as state data, a control amount related to a drive axis when an evaluation program is operated in an industrial machine,
a tool tip error calculation unit configured to perform kinematic transformation on the state data and calculate an error of at least one of machining accuracy and machined surface quality,
a target acquisition unit configured to acquire a target value of the error of at least one of the machining accuracy and the machined surface quality,
a parameter calculation unit configured to compare the error calculated by the tool tip error calculation unit with the target value of the error acquired by the target acquisition unit, and calculate a value of a parameter related to an operation of the industrial machine based on a result of the comparison, and
a parameter adjustment unit configured to adjust the value of the parameter calculated by the parameter calculation unit to the industrial machine.
